(19) United States
(12) Patent Application Publication
(10) Pub. No.: US 2006/0021978 A1
(43) Pub. Date: Feb. 2, 2006

(54) Method for cutting non-metallic materials and device for carring out said method

(76) Inventors: Andrey Mikhaylovich Alexeev, St Petersburg (RU); Viadimir Iosifovich Kryzhanovskiy, St. Petersburg (RU); Oley Viktorovich Khait, St. Petersburg (RU)

Correspondence Address: DAVID A. GUERRA, 317 - 649 MARSH ROAD N.E, CALGARY, AB, T2E 5B4, CA

(21) Appl. No.: 10/505,294

(22) PCT Filed: Feb. 4, 2003
(86) PCT No.: PCT/RU03/00042

§ 371 Date: Jan. 28, 2005

(30) Foreign Application Priority Data
Feb. 21, 2002 (RU) 2002105388

(51) Int. Cl. B23K 26/38; B23K 26/06; C03B 33/02; G06F 19/00

(52) U.S. Cl. 219/121.72; 219/121.73; 700/166

(57) ABSTRACT

The invention relates generally to the methods for machining of materials, dicing nonmetallic materials. More specifically, the present invention relates to a method for laser scribing of transparent non-metallic materials, mainly especially firm (as corundum) with semiconductor coverings, glasses, glass ceramics, ceramics etc. The invention can be used in electronic industry for cutting plates, optical elements, crystals, chipping, clipping liquid crystal indicators and photo masks, magnetic and magneto-optic disks, and also for manufacturing glasses and mirrors, etc. The task of the invention is the creation of a method for cutting transparent nonmetallic, especially firm and extra-firm materials, including materials with semiconductor structure coats, by originally shaped laser beam. The laser pulse with a certain set of parameters provides mechanism for a breakdown of a material by shock and multiphoton ionization, consequently creating the defect of a very small size (close to a diffractional limit), and, due to choosing of correct distance between breakdown points the practical conformity to energy of a laser pulse and energy necessary for formation a crack between 2 breakdown points is reached.

The invention relates generally to the methods for machining of materials, dicing nonmetallic materials. More specifically, the present invention relates to a method for laser scribing of transparent non-metallic materials, mainly especially firm (as corundum) with semiconductor coverings, glasses, glass ceramics, ceramics etc. The invention can be used in electronic industry for cutting plates, optical elements, crystals, chipping, clipping liquid crystal indicators and photo masks, magnetic and magneto-optic disks, and also for manufacturing glasses and mirrors, etc.

The cutting and scribing, finishing edges by diamond tools are traditional methods of processing nonmetal materials such as quartz, leucosapphires etc. The characteristics of such processes are high cost of materials and low percentage of effective articles owing to plenty of labor-intensive consuming hands-on hand-operated operations.

The other method of cutting non-metallic materials consists of heating of a material by laser radiation up to temperature not exceeding temperature of a softening of a material, and then local cooling of a zone of heating. In such case the speed of relative moving of both a beam and both material and a place of local cooling of a zone of heating are chosen from a condition of formation of a crack in a material. (Patent of Russian Federation No 2024441, C03B33/02, publication data Dec. 15, 1994).

This method is characterized by the difficulties at creation of defect of the small size because of the large power of a beam and large length of a wave of radiation and the small accuracy of localization of cutting. The accuracy of cutting also is reduced due to significant local heating of a sample under processing.

The method of laser scribing and destruction of glass layers with a coating is known. This method consists of direction of a laser beam from pulsed CO2 laser with wavelength strongly absorbed by glass, focusing the laser beam on a sample surface or inside the sample, and formations of defect at a point of focusing (patent WO of No 0075983, H01L21/784, publication data Dec. 14, 2000).

A shortcoming of the method and equipment for cutting nonmetallic materials is that, because of losses of material within defect formation area, the defect size is larger than laser spot size and reaches 20 microns or more. This does not suit the requirements of accuracy that necessary for cutting line in division of plates into microchips processes. Besides, the quality of a sample under processing is worsened because of the mentioned heating and the loss of a vaporizable substance from area of cutting and its lodging concretion on a surface.

Similar process is laser scribing and destruction of glass layers with a coating by pulsed KrF laser, which wavelength is strongly absorbed by glass. The laser beam is focused on a surface of a sample or inside the sample, which forms the defect at the point of focusing (patent of U.S. Pat. No. 5,961,852, B23K26/00, publication data Oct. 5, 1999).

The device for realization of this method contains laser system, optical-mechanical system for direction and focusing of radiation, mechanism for sample moving, TV-camera for the process monitoring, computer and controller to manage all electronic systems and process the image.

The limit of this method is that it can be applied only to the certain kind of glasses and coating types due to using the KrF laser. In addition, the low quality of radiation of exciter laser does not allow focusing a laser beam to a small-sized spot, which limits accuracy and raises energy intensity power consumption of process. It should be noted that inherent features of this method are a low speed of cutting because of a low frequency of laser pulses, and a small depth of processing because of strong absorption of this radiation in materials.

The task of the invention is the creation of a method for cutting transparent nonmetallic, especially firm and extra-firm materials, including materials with semiconductor structure coats, by originally shaped laser beam. The laser pulse with a certain set of parameters provides mechanism for a breakdown of a material by shock and multiphoton ionization, consequently creating the defect of a very small size (close to a diffractional limit), and, due to choosing of correct distance between breakdown points the practical conformity to energy of a laser pulse and energy necessary for formation a crack between 2 breakdown points is reached. In case of a dim (mat) back surface of processed sample the threshold of breaking of the sample is lowered. This is a low energy intensive method. The method has small power consumption and allowing with the large degree of accuracy (up to 10 microns) cutting the above-stated materials with thickness from several microns up to 300-500 microns. For thicker samples the cutting can be made by performance of series of defects by focusing of laser radiation to points located at different depths of a sample. The arrangement of focusing points at a backside of a sample allows to satisfy the condition of conformity of density to the value that does not exceed the threshold of destruction of a semiconductor coat, that provides to cut out necessary details without destruction of coverings. This also is promoted by an arrangement of points of formation of defects along a direction of polarization of laser radiation and creation of an additional layer of defects in thicker material perpendicularly surfaces and in parallel to the first layer of points.

The device for cutting of non-metal materials, including ones with semiconductor structure coating, contains laser, optical and mechanical system for direction and focusing of laser beam, the moving mechanics for combining a sample and laser beam focus, TV-camera and control electronics. The optical and mechanics system contains a double-refraction crystal lens or optics combined with two or more lenses with various focal.

The above-stated technical result is reached because a method of cutting dicing of transparent non-metallic materials by a direction of a laser beam from the pulse laser, focusing of laser radiation on a surface of a material or in it, the formations of defect in a focusing point also, using of the impulse laser radiation with length of a wave laying in the field of a transparency of a material, duration of a impulse 10-100 ps and energy in a impulse, sufficient for formation breakdown in a zone of focus, thus form a beam so that density of capacity on a surface did not exceed a threshold of destruction of a semiconductor covering, then determine the size of defect and form defects in points of a material from each other at the on distance determined 50% lapping of defects, up to the double size of defect, thus the points of formation of defects arrange along a direction of polarization of laser radiation, and also make focusing of a beam on a back wall of a sample without a covering, then or simultaneously with first focusing in addition focus one or some times laser radiation within the sample perpendicularly surfaces and in parallel to the first layer of points.

The device for cutting of non-metal materials, including ones with semiconductor structure coating, contains laser, optical and mechanical system for direction and focusing of laser beam, the moving mechanics for combining a sample and laser beam focus, TV-camera and control electronics. The optical and mechanics system contains a double-refraction crystal lens or optics combined with two or more lenses with various focal.

Micro-bursting of sample can be created due to the thermomechanical gradient, as in analogues and prototype, but also by shock ionization in volume resulting to a laser breakdown. This phenomenon is characterized by the threshold on density of energy and capacity of radiation, as it is required to receive an extremely strong electrical field in small volume. Such effect can be achieved by application of super short laser impulses in picosec range. Use thus of Nd:YAG of the laser with length of a wave of the order 1 micron and high quality of a beam allows to receive the small size of focus about units micron, close to diffractional limit, that gives high density of radiation already at low energy of a impulse. Controlled micro-bursting of a sample is reached at the expense of a choice of suitable geometry and polarization of a laser beam, and also spatial arrangement of a sequence of tracks laser breakdown on a sample, namely arrangement of the first directing line of defects near to a back wall of a sample, and also at the expense of a choice of distance between focusing points radiation. Formation in a sample 2 and more tracks of defects provides cutting of thick (more than 300 microns) samples especially of firm materials with declared accuracy. An optimal low threshold of breakdown is created due to special selection of duration of a laser pulse.

Use in the declared device of polyfocal lens consisting from 2 and more of lenses with different focal lengths or a lens from double refraction crystal allows to create the second layer of defects, that also results in increase of accuracy in cutting at the expense of creation inside a sample of the mainly allocated direction for breaking of a sample.

Thus, use of distinctive attributes of the offered invention allows to create a way ensuring an opportunity to within 10 microns of cutting of necessary details without destruction of coverings even from especially of strong materials, having thus by small power consumption.

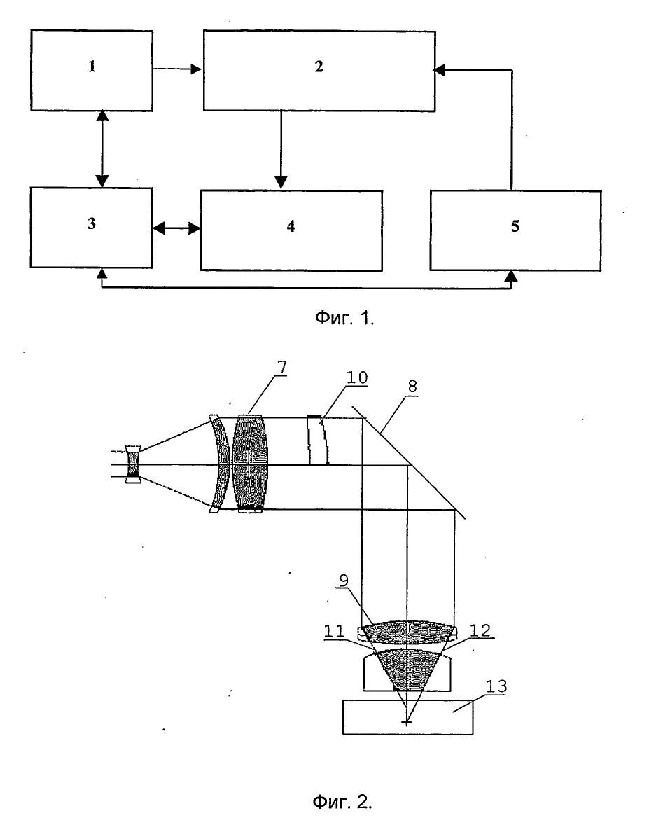

The invention is explained in FIGS. 1-4.

On FIG. 1 the block diagram of installation is shown.

FIG. 2—unit of focusing.

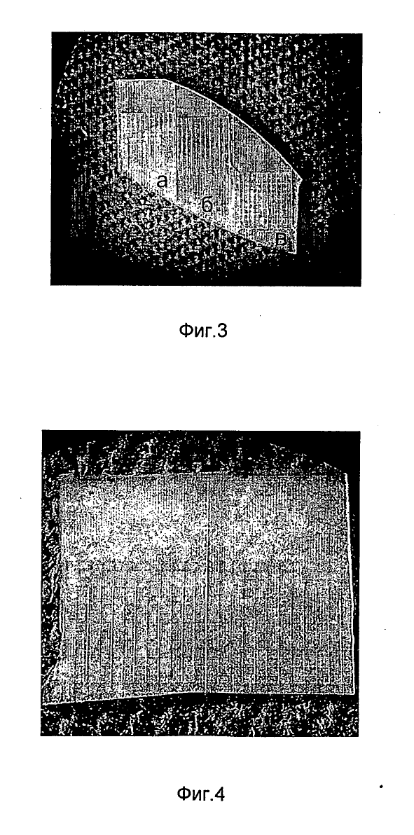

FIG. 3a,6,B—photo of the cut sample of sapphire at 2 values meanings of energy of a pulse—12 and 20 μuJ.

FIG. 4—scribing of samples under different conditions of focusing.

Let's explain the method using the performance of a cutting device given in FIGS. 1 and 2 as an example.

Structure of installation includes the following basic modules:
Laser system 1.
optical-mechanical system of a direction and focusing of radiation 2.
the mechanism of moving of a sample 3.
the video control device 4.
the electronic block of the control and management 5.

The quality and structure of the processed samples and their elements was studied by microscope.

The laser system 1 includes Nd:YAG laser with pulse lamp pumping. The laser pulse was exposed to two-step compression on duration by methods of Mandelshtam-Brilloin induced scattering and Light-Induced Scattering. In result the final duration of pulses made about 15-50 ps, length of a wave of radiation was increased for the account Light-Induced Scattering up to 1.2 microns, energy in a pulse up to 100 μJ. Standard frequency of following of pulses 15 Hz. For a variation of energy in a pulse approximately in 2 times on ways of a beam it was possible to set establish neutral 60% the filter.

The focusing system 2, shown on FIG. 2, consists of collimating optics (telescopic system) 7, dichroic rotary mirror 8 and focusing lens 9 with the opportunity of moving in a vertical direction. Thus, we could scanned the area of focusing of radiation manually on depth of a sample. The position of objective was controlled by micrometer to within 5 microns. Lenses 9 with a focal length 8 and 15 mm were used. Set in established between system 7 and mirror 8 lenses 10 (or the lens from double reflection crystal with 2 focal lengths allowed to focus beams 11 and 12 in different places on the height of a sample.

Glass plate by 12 thickness of 1.2 mm and sapphire plate by thickness about 0.4 mm without sprayed covering with in regular intervals sprayed GaN and with sprayed semiconductor grid with a step 430 microns were used for study of occurrence of cracks as a result of a laser breakdown. Sapphire plates were transparent and polished on the part of covering and rough—dim with opposite.

The cross diameter of caustic of a laser beam in focus was estimated appreciated in 4-8 microns under the image of a track in thicker sample, where the threshold of breakdown was high, and size of a crater was minimal, that practically coincided with diffractional limit.

First cutting by a beam of the laser 1 was rendered through the transparent party near to a back rough wall. The depth of a track of area laser breakdown made of the order 50 microns for objective with F=8 mm and 80 microns for F=15 mm. Scribing of a back wall of a plate 13 was carried out at the 2 values meanings of energy of a pulse—20 and 12 μJ. The guaranteed allowable size of defects of a surface up to 10 microns was created for a low power value meaning. The sample of cutting for energy in a pulse 12 μJ is shown on FIG. 3a, 20 μJ is shown on FIG. 36, 20 μJ is shown on FIG. 3B with 2 layers of defects. The area of damages and deviation of a surface of split from a cutting line did not exceed 10 microns for the cutting on directions of crystallographic axes, but at concurrence of a cutting line with crystallographic axis the deviation was defined by accuracy of positioning focal stain.

For controlling management of a growth of a crack second additional cutting at some distance from a back surface was carried out. Such cutting created additional cracks in the given direction inside volume of a sample, that resulted in sharp decrease of a mechanical threshold at a break and controllable direction of a break. The two-beam geometry of beam to a cutting zone with the help of half of positive lens 10 with a focal length about 2 m was used. Thus in glass the beams missed on height on 120 microns for objective with F=15 mm, and in sapphire the divergence made 180 microns because of the greater parameter of refraction. The structure of cracks, created by such method, have allowed to receive satisfactory breaking of a sapphire plate on microelements with the party 400 microns by rolling with the special roller platen. Scribed samples with defects put with the help double focusing on different depths of layers of defects within the sample are shown on FIG. 4.

Short-focus objective with F=8 mm was used for scribing of samples with a semiconductor covering. It has allowed completely to remove cauterization of covering at energy of a pulse μJ and duration of a pulse 30 picoseconds owing to creation of density of energy of radiation on a surface of a sample are less than threshold of destruction of a covering.

The mechanisms of occurrence laser breakdown in dielectrics were studied within the last decade in connection with development femtosecond laser engineering. In work As-Chun Tien at al (Phys. Rev. Letters, 1999, v.82, N. 19, pp. 3883-3886) the contribution of various mechanisms of ionization to occurrence laser breakdown is investigated depending on duration of a laser pulse in a range from hundreds picoseconds up to tens femtoseconds.

The breakdown in transparent environments is determined by fast increase of electron density in a zone of conductivity up to a critical level necessary for occurrence of strong absorption of laser radiation by arising plasma. As a result the destruction of environment occurs under action of a formed shock wave in plasma. We can consider the mechanism of initiation in used range about 30 ps from diagrams of threshold density of breakdown energy as the functions of duration of a pulse from this paper. In a zone of conductivity of firm bodies due to presence of impurity always there is always some free electrons in a zone of conductivity of firm bodies due to presence of impurity. Under action of a very strong electrical field of a laser wave about hundreds MV/cm there is an acceleration of electrons up to energy, sufficient for shock ionization of atoms of a lattice. As a result the electronic avalanche develops which quickly reaches critical density. Mechanism of shock ionization was confirmed by the significant reduction of a threshold of breakdown on a non-uniform rough surface because of the increased quantity of defects of a lattice.

Mechanism of multiphotonic ionization begins to work at duration of a pulse in units of picoseconds the, however, it gives the basic contribution for shorter 1 ps. At the same time density of energy breakdown is proportional to a square root from duration for a pulse down to values meanings of duration of the order 10 ps, and further reduction of a pulse provide nonlinear behavior but is close to constant value meaning (for example, about 1 J/cm2 for fused quartz).

The considered shock mechanism can result in dependence of breakdown geometry in a firm body from a direction of polarization of a laser beam. As electrons are accelerated along a direction of an electrical field, i.e. vector of polarization, also primary direction of growth of an electronic avalanche should settle down along this direction. Thus, a plasma cloud and arising shock wave should have the form extended along a direction of polarization. Hence, and the form of a crack will be narrower and long at an arrangement of consecutive points of laser impacts along a direction of polarization and, accordingly, more enlarged and rough across this direction. It should also result in reduction of a mechanical threshold of a break of plates along cutting lines for beam directed on polarization.

On this basis it is possible to explain the chosen range duration of a pulse. At duration of a pulse there are less than 10 ps, as it is visible from above-stated diagram working breakdown mechanism, alongside with shock, becomes multiphotonic and tunnel ionization. As it is known from practice, at duration of a pulse about hundreds femtosecond and shorter there are strong nonlinear effects, which result, on the one hand, in impossibility to focus a laser beam in a stain of the necessary small size, and, with another—to updating a parameter of refraction and turbidity of a transparent material. These mechanisms practically exclude an opportunity laser breakdown in volume of a substrate and, therefore, are unsuitable for are sharp. As it is known from practice turn, the range of duration's of a pulses approximately from 500 femtosecond up to units of picoseconds is extremely difficult for realizing practically, by receiving thus acceptable frequency parameters in a range from tens Hertz up to tens κHz (the mode of synchronization of styles gives frequencies of recurrences in tens and hundreds MHz). Lastly, under duration of pulses there are more than 100 ps owing to growing of energy putting the area of defect is considerably increased, also begin to have an effect of a thermal gradient, that as a result entails to lowering reduction of the declared accuracy.

Thus, use of the mechanism of shock ionization has allowed creating to create a method of scribing especially of firm non-metallic materials with a semi-conductor covering ensuring accuracy of cutting for these materials up to 10 microns.

What is claimed is:

1. Method for cutting of nonmetallic materials by a direction of a laser beam from the pulse laser, focusing of laser radiation on a surface of a sample or in it, the formations of defect in a point of focus, and then application of mechanical effort to a surface of a sample distinguished by the fact of themes, that it is used pulse laser radiation 10-100 ps duration of a pulse and energy in a pulse, sufficient for formation of breakdown in a zone of focus, with length of a wave laying in the field of a transparency of a material, then determine the size of defect and form defects in points of a sample from each other at the on distance determined 50% overlapping of defects on 50% up to double distance between defects, at the same time form a beam so that density of energy on a surface did not exceed a threshold of destruction of a semiconductor covering.

2. Method for cutting of transparent nonmetallic materials according to claim 1, wherein points of formation of defects are along a direction of polarization of laser radiation.

3. Method for cutting of transparent nonmetallic materials according to claim 1, wherein focusing a beam are focused on a back wall of a sample without a covering, then or simultaneously with first focusing additionally focus one or several times laser radiation in sample perpendicularly surfaces and in parallel to the first layer of defects.

4. The device for cutting of transparent nonmetallic materials containing laser system, optical-mechanical system of a direction and focusing of radiation, mechanism of mutual moving of a sample and focal stain, TV-control device, block of management and control, distinguished by the fact themes, that the system for a direction and focusing of radiation is executed with a lens consisting of 2 and more of lenses with different focal lengths.

5. The device according to claim 4, wherein the system for a direction and focusing of radiation is executed with a lens from double reflection of a crystal.
